(19) United States
(12) Patent Application Publication
(10) Pub. No.: US 2022/0363604 A1
(43) Pub. Date: Nov. 17, 2022

(54) HYDROFLUX-ASSISTED DENSIFICATION

(71) Applicant: The Penn State Research Foundation, University Park, PA (US)

(72) Inventors: Jon-Paul Maria, State College, PA (US); Sarah Lowum, State College, PA (US); Richard Floyd, State College, PA (US)

(21) Appl. No.: 17/765,469

(22) PCT Filed: Oct. 1, 2020
(86) PCT No.: PCT/US2020/053729

§ 371 Date: Mar. 31, 2022

Related U.S. Application Data
(60) Provisional application No. 62/910,743, filed on Oct. 4, 2019.

(51) Int. Cl. C04B 35/63; C04B 35/453; C04B 35/45; C04B 35/01; C04B 35/26; C04B 35/495; C04B 35/632; C04B 35/653; C04B 35/64

(52) U.S. Cl. CPC C04B 35/6303; C04B 35/453; C04B 35/45; C04B 35/016; C04B 35/2658; C04B 35/495; C04B 35/6325; C04B 35/653; C04B 35/64; C04B 2235/3284; C04B 2235/3281; C04B 2235/3262; C04B 2235/3258; C04B 2235/3298; C04B 2235/3274; C04B 2235/3255; C04B 2235/48; C04B 2235/3201; C04B 2235/604

(57) ABSTRACT

Embodiments relate to an improved hydroflux assisted densification process that introduces a transport phase (formed by the introduction of water during the process to suppress melting temperatures) for sintering, the transport phase being a non-aqueous solution. The process can facilitate sintering at low temperature ranges (at or below 300° C.) to yield densification>90% without the need for additional post-processing steps that otherwise would be needed if conventional processes were used. Control of the pressures and water content used during the process can enhance densification mechanisms related to dissolution-reprecipitation, allowing for a greater range of compositional spectra of materials that can be densified, a reduction of the amount of transport phase needed, a reduction of impurities and an improvement of properties in the densified material. Certain hydrated acetate powders can be used to generate a hydroxide mixture flux that is better for the low-temperature densification process.

### CROSS-REFERENCE TO RELATED APPLICATIONS

This application is related to and claims the benefit of U.S. provisional application No. 62/910,743 filed on Oct. 4, 2019, the entire contents of which is incorporated herein by reference.

### STATEMENT REGARDING FEDERALLY SPONSORED RESEARCH OR DEVELOPMENT

This invention was made with government support under Grant Nos. IIP1361571 and IIP1361503 awarded by the National Science Foundation. The Government has certain rights in the invention.

### FIELD OF THE INVENTION

Embodiments relate to an improved hydroflux assisted densification process that introduces a transport phase (formed by the introduction of bound water during the process to suppress melting temperatures) for sintering, the transport phase being a non-aqueous material. The process can facilitate sintering at low temperature ranges (at or below 400° C., and preferred at or below 200° C.) to yield densification>80% (preferred >90%) without the need for additional post-processing steps that otherwise would be needed if conventional processes were used.

### BACKGROUND OF THE INVENTION

Conventional densification systems and methods fail to exploit factors that mediate dissolution and reprecipitation processes, which (if properly exploited) can be used to tailor ceramic powder formulations so that they can be more easily densified at low temperatures.

Examples of known systems and methods related to densification and sintering of materials can be appreciated from U.S. Pat. Nos. 8,313,802, 4,393,563, 4,599,277, 5,098,469, U.S. Pat. Publ. No. 2017/0088471, U.S. Pat. Publ. No. 2008/0171647, U.S. Pat. Publ. No. 2004/0159390, International Application No. WO 2019/040864, and Kahari, Hanna et al., Improvements and modifications to room-temperature fabrication method for dielectric Li₂MoO₄ ceramics', Journal of the American Ceramic Society 22 Jan. 2015, Vol. 98, No. 3, pp. 687-689.

### SUMMARY OF THE INVENTION

Embodiments relate to an improved hydroflux assisted densification process that introduces a transport phase (formed by the introduction of water during the process to suppress melting temperatures) for sintering, the transport phase being a non-aqueous material best classified as a solid solution. The process can facilitate sintering at low temperature ranges (at or below 300° C.) to yield densification>90% without the need for additional post-processing steps that otherwise would be needed if conventional processes were used. Control of the pressures and water content used during the process can enhance densification mechanisms related to dissolution-reprecipitation or other transport mechanisms, allowing for a greater range of compositional spectra of materials that can be densified, a reduction of the amount of transport phase needed, and an improvement of properties in the densified material. Certain hydrated acetate powders, as one example, can be used to generate a solid solution flux mixture that is better for the low-temperature densification process as compared to liquid solutions based on aqueous transport phase.

In an exemplary embodiment, a method of forming a mixture to be densified involves combining a transport phase with an inorganic compound to form a mixture, wherein the transport phase is configured to assist with redistribution of particulate material during densification.

In some embodiments the method involves before, during, or after the mixture is formed, adding structural water to the transport phase to form a solid solution (i.e., it is incorporated into the solid and the mixture remains a crystalline solid) that is within a range from 1% to 20% by weight of water. The water is added to the transport phase to form a solid solution that is within a range from 1% to 20% by weight of water. Note: The concentration of water regulates the temperature at which densification initiates, and the “densification power” of the transport phase, i.e., a certain amount is needed to achieve full density.

In some embodiments, the transport phase includes any one or combination of water, water mixed with soluble salts, C1-12 alcohol, ketone, ester, organic acid, and organic acid mixed with soluble salts.

In some embodiments, the transport phase is configured to have a boiling point within a range from 100° C. to 1000° C.

In some embodiments, the inorganic compound includes any one or combination of a ceramic, a metal oxide, a lithium metal oxide, a non-lithium metal oxide, a metal carbonate, a metal sulfate, a metal selenide, a metal fluoride, a metal telluride, a metal arsenide, a metal bromide, a metal iodide, a metal nitride, a metal sulphide, and a metal carbide.

In some embodiments, the inorganic compound includes any one or combination of ZnO, Li₂MoO₄, KH₂PO₄, V₂O₅, NaCl, MoO₃, NaCl, Li₂CO₃, BiVO₄, LiFePO₄, Li_{1.5}Al_{0.5}Ge_{1.5} (PO₄)₃, WO₃, ZnTe CsSO₄, AgVO₃, LiCoPO₄, Li_{0.5x}Bi_{1-0.5x}MoₓV₁₋ₓO₄, V2O₃, AgI, Li₂MoO₄, Na₂ZrO₃, KH₂PO₄, V₂O₅, CuCl, Na₂Mo₂O₇, BaTiO₃, Ca₅(PO₄)₃(OH), ZnO, ZrF₄, K₂Mo2O₇, NaNO₂, (LiBi)_{0.5}MoO₄, Bi₂O₃, α-Al₂O₃, ZnMoO₄, Mg₂P2O₇, CsBr ZrO_{2PSZ} Li2WO4 BaMoO₄, MgO ZrO_{2Cubic}, Na₂WO₄, Cs₂WO₄, PbTe, K₂VO₄, NaₓCO₂O₄, Bi₂Te₃, Bi₂VO₄, Ca₃Co4O₉, LiVO₃, KPO₃, SrTiO₃, LiCoO₂, BaCl₂, Bi₂O₃, B2O₃, KOH, PbO, and Na₂CO₃.

In an exemplary embodiment, a mixture formulation for a sintered material includes: an inorganic compound; and a transport phase configured to assist with redistribution of particulate material during densification.

In some embodiments, the transport phase is a solid solution of an organic, inorganic, or hybrid salt and water within a range from 1% to 20% by weight of water, wherein the water-salt combination produces solubility required for a particulate phase to facilitate densification.

In some embodiments, the transport phase includes any one or combination of water, water mixed with soluble salts, C1-12 alcohol, ketone, ester, organic acid, and organic acid mixed with soluble salts.

In some embodiments, the transport phase is configured to have a boiling point within a range from 100° C. to 1000° C.

In some embodiments, the inorganic compound includes any one or combination of a ceramic, a metal oxide, a lithium metal oxide, a non-lithium metal oxide, a metal carbonate, a metal sulfate, a metal selenide, a metal fluoride, a metal telluride, a metal arsenide, a metal bromide, a metal iodide, a metal nitride, a metal sulphide, and a metal carbide.

In some embodiments, the inorganic compound includes any one or combination of ZnO, Li₂MoO₄, KH₂PO₄, V₂O₅, NaCl, MoO₃, NaCl, Li₂CO₃, BiVO₄, LiFePO₄, Li_{1.5}Al_{0.5}Ge_{1.5} (PO₄)₃, WO₃, ZnTe CsSO₄, AgVO₃, LiCoPO₄, Li_{0.5x}Bi_{1-0.5x}MoₓV₁₋ₓO₄, V2O₃, AgI, Li₂MoO₄, Na₂ZrO₃, KH₂PO₄, V₂O₅, CuCl, Na₂Mo₂O₇, BaTiO₃, Ca₅(PO4)₃(OH), ZnO, ZrF₄, K₂Mo2O₇, NaNO₂, (LiBi)_{0.5}MoO₄, Bi₂O₃, α-Al₂O₃, ZnMoO₄, Mg₂P2O₇, CsBr ZrO_{2PSZ} Li2WO4 BaMoO₄, MgO ZrO_{2Cubic}, Na₂WO₄, Cs₂WO₄, PbTe, K₂VO4, NaₓCO₂O₄, Bi₂Te₃, Bi₂VO₄, Ca₃Co4O₉, LiVO₃, KPO₃, SrTiO₃, LiCoO₂, BaCl₂, Bi₂O₃, B2O₃, KOH, PbO, and Na₂CO₃.

In an exemplary embodiment, a method of forming a densified material involves: combining a transport phase with an inorganic compound to form a mixture; allowing fluxes to form in the mixture; and applying pressure and temperature to promote mass transport and particle consolidation to a dense and robust polycrystalline body that is a compact.

In some embodiments, generating the densified material consists essentially of: combining a transport phase with an inorganic compound to form the mixture; adding water to the transport phase before, during, or after combining the transport phase with the inorganic compound; allowing fluxes to form in the mixture; applying pressure and temperature to activate mass transport between grains of inorganic material of the inorganic compound leading to densification; providing sufficient time (preferred is hours, more preferred is 10s of minutes, and most preferred is 1-10 minutes) to convert an initial particle compact into a dense and robust polycrystalline body.

In some embodiments, the method involves allowing the transport phase to partially solubilize the inorganic compound to form the mixture.

In some embodiments, the method involves: adding water to the transport phase before, during, or after combining the transport phase with the inorganic compound; and allowing the added water to suppress the melting temperature of the transport phase during the application of pressure and temperature, causing either more rapid transport at elevated temperatures or transport at net lower temperatures.

In some embodiments, the method involves allowing a high-temperature melt of the initially solid transport phase material, melted during the application of pressure and temperature to dissolve precursor material in one location of the compact, and promote nucleation of new crystals in another location of the compact.

In some embodiments, the method involves generating a hydro-flux that spans a regime between flux growth and hydrothermal growth so that an intersection of hydrothermal and flux-based crystal growth in the phase diagram introduces a mass transport phase at temperatures at or near a boiling point of the transport phase, the mass transport phase being a non-aqueous solution.

In some embodiments, applying pressure involves applying pressure within a range from 30 Mpa to 5,000 Mpa (preferred is <5 Gpa, more preferred is <1 Gpa, and most preferred is <0.1 Gpa).

In some embodiments, applying temperature involves applying temperature within a range from 100° C. to 300° C.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 is an exemplary flow diagram of an embodiment of the sintering process.

FIG. 2 is a temperature v. water plot illustrating the suppression of temperature of fluxes that can be achieved via an embodiment of the process.

FIG. 3 is an exemplary sinteometer that may be used for carrying out an embodiment of the process.

FIG. 4 is an exemplary pellet die that may be used with an embodiment of the sinterometer of FIG. 3.

FIG. 5 shows densities of resultant CuO sintered material, Bi₂O₃ sintered material, ZnO sintered material, WO₃ sintered material, MnO sintered material, NiO sintered material, and BaFe₁₂O₁₉ (barium hexaferrite) sintered material (as well as an XRD plot for BaFe₁₂O₁₉) that have been densified via an embodiment of the process.

FIG. 6 shows microstructure image densities of resultant KNN sintered material that has been densified via an embodiment of the process.

FIG. 7 shows microstructure image densities of resultant ZnFe₂O₄ sintered material that has been densified via an embodiment of the process.

FIG. 8 is a normalized compaction vs. time traces plot for the an exemplary process carried out via an embodiment of the sinterometer and for an exemplary process carried out via a manual press, wherein the inset shows a discontinuity in the manual press trace where the operator reapplied pressure to the densifying compact.

FIG. 9 is a compaction vs. time plot for a ZnO sample densified with a 0.4 M Zn(OAc)2 solution at 120° C. and 530 MPa for 6 hrs. Sample density is indicated at 0 min, 30 min, and 6 hrs, and the inset presents corresponding thermogravimetric analysis (TGA) traces that show sample has no measurable mass loss after 30 minutes of compaction, indicating no remaining bound or liquid water.

FIG. 10 shows microstructure image densities of ceramics densified at 300° C. or below by an embodiment of the process: a) ZnO, b) ZnO, c) CuO, d) Bi₂O₃, e) ZnFe₂O₄, f) KₓNa₁₋ₓNbO₃. The selected transport phase and final relative density are indicated on each image.

FIG. 11 shows microstructure image densities of ZnO samples densified by an embodiment of the process using NaK as the transport phase at 200° C. and 530 MPa for 30 minutes. All samples were made within a two week period using the same conditions yet (a) shows a dense (98%) microstructure with no obvious secondary phases, (b) shows compacted powder that did not densify, and (c) shows a sample with a measured density>90% but the microstructure is full of a secondary phase.

FIG. 12 shows SEM images of ZnO densified at 200° C. and 530 MPa for 30 minutes using 2 vol. % of (Na,K)OH. The sample in (a) was pressed “dry” and only achieved a density around 80%, while the sample in (b) had 5 vol. % of added H₂O and a density of 97%.

FIG. 13 shows a probability of failure vs. failure stress for cold-sintered ZnO samples (20 vol. % 0.8 M Zn(OAc)₂ aqueous solution, 120° C., 30 min, 530 MPa) tested through the B3B method. Solid line represents the best fit, and dashed lines show the 90% confidence intervals.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

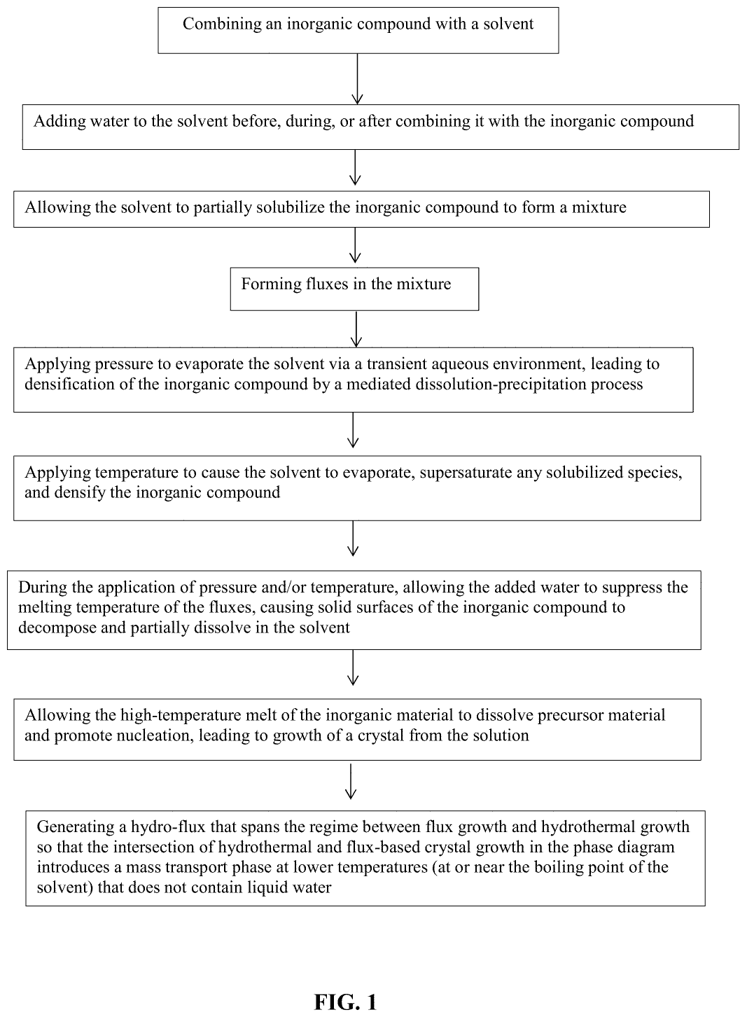

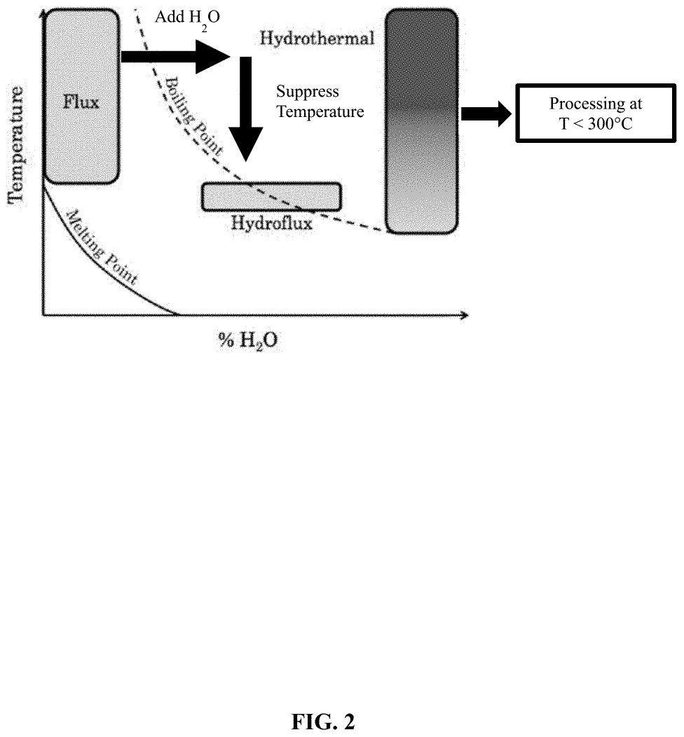

Referring to FIGS. 1-4, embodiments relate to an improved hydroflux assisted densification process. A hydro-flux assisted densification process can be a process that introduces a mass transport phase for sintering compounds into a densified material. The mass transport phases in many cases are a solid solution of water and an ionic salt that are added to the starting ceramic powder, and which can be formed during the sintering process. During a heat treatment in the vicinity of 200° C. the transport phase melts and acts as a transport phase for redistribution of the particulate material phase under pressure which produces densification. Embodiments of the process can facilitate sintering at low temperature ranges (e.g., at or below 300° C.) to yield densification greater than 90% (“>90%”) without the need for additional post-processing steps that otherwise would be needed if conventional processes were used.

Control of the pressures involved and the water content used during the process can enhance densification mechanisms related to dissolution-reprecipitation or other mass transport mechanisms. In some embodiments, use of hydrated acetate powders can generate a hydroxide mixture flux that is better for the low-temperature densification process. As will be explained herein, using any one or combination of these process steps can result in a greater range of compositional spectra of materials that can be densified. These process steps can further lead to a reduction of the amount of mass transport phase needed. These process steps can also lead to more consistency in material properties (e.g., a reduction of porosity, an improvement of properties due to uniform consolidation, more consistent microstructures, etc.) of the densified material.

Embodiments of the process can involve a sintering process. The sintering process can be a cold sintering process. Embodiments of the cold sintering process can involve combining an inorganic compound, in particle form, with a transport phase. The transport phase can be selected to partially solubilize the inorganic compound to form a mixture. It is contemplated for the transport phase to be a solid solution between two or more component phases. Moderate pressure can be applied (e.g., within a range from 30 Mpa to 5,000 Mpa) at low temperatures (e.g., within a range from 100° C. to 300° C. or 150° C. to 200° C. or 150° C. to 300° C.) to the mixture. The application of pressure and temperature can promote mass transport, leading to densification of the inorganic compound by a mediated dissolution-precipitation or other mass transport phenomena. For instance, the application of pressure can provide the force needed to sinter the inorganic compound. In some cases, the application of temperature can cause the transport phase to evaporate, supersaturate any solubilized species, and densify the inorganic compound. The densification of the inorganic compound forms a sintered material. The resultant sintered material has a reduced porosity, which can lead to improved strength, conductivity, translucency, heat capacity, etc. Envisioned applications include: capacitors, permanent magnets, refractories, near-net-shape ceramics, varistors, and actuators. The biggest benefit is the low temperature process. This affords one a new ability to control ceramic grain size and final defect chemistry in a way not possible with conventional high temperature sintering. Grain size and defect chemistry are instrumental determiners of physical properties. Also, one can densify ceramic bodies that decompose before reaching a sufficiently high temperature to sinter—i.e., Mg(OH)2—a possibly interesting material for hydrogen storage.

In some embodiments, water can be added to the transport phase to create a solid solution with a lower melting temperature and an enhanced mass transport capacity. During the sintering process, fluxes are generated in the mixture. The addition of water to the transport phase can suppress the melting temperature of the fluxes that becomes apparent when the pressure and temperature are applied. The transport phase-inorganic mixture allows inorganic compound particles to be uniformly exposed to a small amount of transport phase so that solid surfaces of the inorganic compound decompose and partially dissolve in the transport phase, thereby leading to a controlled amount of liquid phase being intentionally introduced at the particle-particle interface. This transport phase will in some cases form a low temperature liquid, but melting of the transport phase is not an essential characteristic. At elevated temperatures and pressure, the transport phase dissolves precursor material and then promotes nucleation, leading to growth of a crystal from the solution. Thus, the transport phase, either molten or sometimes in solid state, functions as a transport phase for mass transport, crystallization, and densification. The water added to the transport phase can suppress the melting point of many fluxes, and/or make them transport material more effectively, resulting in a hydro-flux that spans the regime between flux growth and hydrothermal growth. These hydro-fluxes (e.g., hexahydroxometallate) can be used to generate a mass transport phase. For instance, the intersection of hydrothermal and flux-based crystal growth in the phase diagram introduces a mass transport phase at lower temperatures (at or near the boiling point of the transport phase) that does not contain liquid water—i.e., the transport phase is non-aqueous solution. The combination of the added mass transport phase and the use of moderate pressures can enhance densification in materials when being sintered at relatively low temperatures.

It should be noted that the introduction of the transport phase to the inorganic compound should be controlled so that dissolution of sharp edges of solid particles of the inorganic compound particles can reduce the interfacial areas, allowing for capillarity forces to aid in the rearrangement of the particles for the densification. It is believed that with the assistance of sufficient external and capillarity pressure, the liquid phase can redistribute itself and fill into the pores between the particles. Applying a uniaxial pressure, the solid particles can rearrange rapidly, which collectively leads to an initial densification. A subsequent growth stage (e.g., solution-precipitation), can be created through transport phase redistribution that promotes regions of supersaturation that locally promote precipitation and densification (e.g., a temperature where mass transport is rapid, and may be in proximity to the melting or vaporization point of any constituents in the system). This can trigger a large chemical driving force for the solid and transport phases to reach high levels of densification.

With embodiments of the sintering process disclosed herein, dissolution and reprecipitation events facilitated by the mass transport phase can lead to porosity elimination and the formation of a dense microstructure for the sintered material. As will be demonstrated herein, control of transport phase composition and pressure can mediate the dissolution and reprecipitation process, leading to the ability to tailor inorganic compound formulations so that they are more easily densified at low temperatures. This can expand the compositional spectra of materials that can be densified, and in particular expand the compositional spectra of materials that can be densified to >90% at temperatures at or below 300° C. without the need to perform post-processing steps. In addition, tailoring the flux-based transport phase to the specific inorganic compound being used can further enhance densification at the low temperatures. This can further minimize the added transport phase that otherwise would be needed, thereby reducing impurities in the sintered material.

In some embodiments, the sintering process can be used to generate a sintered composite. For instance, the cold sintering process can involve combining a first compound and a second compound with a transport phase. Any one or combination of the first compound and the second compound can be in particle form. The first compound can be the same as or different from the second compound. It is contemplated for at least one of the first compound and the second compound to be an inorganic compound. For instance the first compound can be an inorganic compound. The second compound can be an inorganic compound, an organic compound, a polymer, a metal, glass, carbon fiber, etc. The transport phase can be selected to partially solubilize the first inorganic compound and/or the second inorganic compound to form a mixture. Pressure can be applied at low temperatures to the mixture. The application of pressure and temperature can evaporate some, all, or no components of the transport phase via a transient aqueous environment, leading to densification of the first compound and the second compound to form a sintered composite material. It should be noted that any number of compounds can be used.

In some embodiments, the sintering process can be used to generate a sintered material on a substrate and/or a sintered composite on a substrate. For instance, the process can involve depositing the at least one inorganic compound onto a surface of a substrate. The substrate can be metal, ceramic, polymer, etc. The process can involve combining the at least one inorganic compound, in particle form, with a transport phase before, during, and/or after depositing the at least one inorganic compound onto the surface of the substrate. The transport phase can be selected to partially solubilize the at least one inorganic compound to form a mixture. Pressure can be applied at low temperatures to the mixture. The application of pressure and temperature can evaporate some, all, or no components of the transport phase via a transient aqueous environment, leading to densification of the at least one inorganic compound to form a sintered material on the substrate and/or sintered composite on the substrate. It should be noted that more than one substrate can be used (e.g., a layered structure or a laminate structure can be formed). For instance, the process can involve depositing the at least one inorganic compound onto a surface of a first substrate. The process can involve combining the at least one inorganic compound, in particle form, with a transport phase before, during, and/or after depositing the at least one inorganic compound onto the surface of the first substrate. The transport phase can be selected to partially solubilize the at least one inorganic compound to form a mixture. Pressure can be applied at low temperatures to the mixture. The application of pressure and temperature can evaporate some, all, or no components of the transport phase via a transient environment, leading to densification of the at least one inorganic compound to form a sintered material and/or sintered composite on the first substrate. The process can involve forming a second substrate on the sintered material and/or the sintered composite. The process can involve depositing the at least one inorganic compound onto a surface of a second substrate. The process can involve combining the at least one inorganic compound, in particle form, with a transport phase before, during, and/or after depositing the at least one inorganic compound onto the surface of the second substrate. The transport phase can be selected to partially solubilize the at least one inorganic compound to form a mixture. Pressure can be applied at low temperatures to the mixture. The application of pressure and temperature can evaporate some, all, or no components of the transport phase via a transient aqueous environment, leading to densification of the at least one inorganic compound to form a sintered material and/or sintered composite on the second substrate.

An exemplary method of carrying out an embodiment of the sintering process can involve converting an inorganic compound to powder form. The inorganic compound can be made into a fine powder, for example. The particle size for the powder material can range from 1 nanometer to 100 micrometers. This can be achieved by milling the inorganic compound by a comminution process (e.g. grinding, milling, ball milling, attrition milling, vibratory milling, jet milling, etc.). The method can further involve combining the inorganic compound with a transport phase. The method can further involve adding water to the transport phase before, during, or after combining it with the inorganic compound. The method can further involve allowing the transport phase to partially solubilize the inorganic compound to form a mixture. The method can further involve forming fluxes in the mixture. The method can further involve applying pressure to evaporate the transport phase via a transient aqueous environment, leading to densification of the inorganic compound by a mediated dissolution-precipitation process. The method might in some cases further involve applying temperature to cause the transport phase to evaporate, supersaturate any solubilized species, and densify the inorganic compound.

For instance, the mixture can be placed on a die 110 of a sinterometer 100. The sinterometer 100 can be a constant pressure hydraulic press 102 with a linear displacement sensor 108. The hydraulic press 102 can be secured to a load frame 106 with the pellet die 110. The pellet die 110 can be configured to receive and retain a volume of the mixture. The hydraulic press 102 can be actuated to impart pressure onto the mixture by advancing a hydraulic cylinder 104 towards the pellet die 110. The pellet die 110 and the load frame 106 can be configured to withstand the force of the hydraulic cylinder 104 so as to transfer the force to the mixture, thereby imparting pressure onto the mixture. The linear displacement sensor 108 can be attached to the hydraulic cylinder 104 of the hydraulic press 102 and be configured to measure linear displacement thereof as a proxy for pressure being applied. It is contemplated for the pressures applied to be within the range from 30 Mpa to 5,000 Mpa. The application of pressure can aid in the sintering of the inorganic particles while the transport phase evaporates. The pellet die 110 can be a shaft coupler 112 configured to receive a drill bushing 114 and at least one punch 116. The shaft coupler 112 can be made from stainless steel. The drill bushing 114 and at least one punch 116 can be made from tungsten carbide. A heater band 118 can be removably secured to the shaft coupler 112, and be connected to an electrical power source for applying the heat to the pellet die 110, which is transferred to the mixture when the mixture is placed therein. It is contemplated for the temperature applied to be at or below 300° C. More specifically, the temperatures applied can be at or near the boiling point of the transport phase. For instance, the temperature applied can be within a range from 0° C. to 400° C. above the boiling point of the transport phase. The application of heat can cause the transport phase to evaporate, supersaturate any solubilized species, and densify the inorganic compound to form the sintered material and/or the sintered composite.

In an exemplary embodiment, the first punch 116 is inserted into the coupler 112, and the mixture is deposited into the coupler 112 so as to rest on top of the first punch 116. The second punch 116 is inserted into the coupler 112 to rest on top of the mixture. The hydraulic cylinder 104 can be advanced to impart pressure to the second punch 116 while the first punch 116 is pressed against the load frame 106. As the hydraulic cylinder 104 is further advanced, the first and second punches 116 impart pressure to the mixture.

The method can further involve, during the application of pressure and/or temperature, allowing the added water to suppress the melting temperature of the fluxes, causing solid surfaces of the inorganic compound to decompose and partially dissolve in the transport phase. The method can further involve allowing the high-temperature melt of the inorganic material to dissolve precursor material and promote nucleation, leading to growth of a crystal from the solution. The method can further involve generating a hydro-flux that spans the regime between flux growth and hydrothermal growth so that the intersection of hydrothermal and flux-based crystal growth in the phase diagram introduces a mass transport phase at lower temperatures (at or near the boiling point of the transport phase) that does not contain liquid water.

It is contemplated for the transport phase to be an inorganic or an inorganic-organic, or an organic-organic solid solution. The transport phase can include any one or combination of water, water mixed with ionic or organic salts, C₁₋₁₂ alcohol, ketone, ester, organic acid, organic acid mixed with soluble salts, etc. In some embodiments, any of C₁₋₁₂ alcohol, ketone, ester, organic acid, inorganic hydroxide, acetate, formate, or organic acid mixed with soluble salts can be combined with water to form the aqueous solution. For instance, any of C₁₋₁₂ alcohol, ketone, ester, organic acid, or organic acid mixed with soluble salts can be combined with water to form a transport phase that is a solid solution containing 0.1 to 20 mol % water. In some embodiments, the transport phase Other components can be added to control, modify, or influence pH, kinetics, etc. of the transport phase.

It is contemplated for the inorganic compound to be any one or combination of a ceramic, a metal oxide, a lithium metal oxide, a non-lithium metal oxide, a metal carbonate, a metal sulfate, a metal selenide, a metal fluoride, a metal telluride, a metal arsenide, a metal bromide, a metal iodide, a metal nitride, a metal sulphide, a metal carbide, etc. Some specific inorganic compounds can be ZnO, Li2MoO₄, KH2PO₄, V₂O₅, NaCl, MoO₃, NaCl, Li₂CO₃, BiVO₄, LiFePO₄, Li_{1.5}Al_{0.5}Ge_{1.5} (PO₄)₃, WO₃, ZnTe CsSO₄, AgVO₃, LiCoPO₄, Li_{0.5x}Bi_{1-0.5x}MoₓV₁₋ₓO₄, V2O₃, AgI, Li₂MoO₄, Na₂ZrO₃, KH₂PO₄, V₂O₅, CuCl, Na₂Mo₂O₇, BaTiO₃, Ca₅(PO4)₃(OH), ZnO, ZrF₄, K₂Mo2O₇, NaNO₂, (LiBi)_{0.5}MoO₄, Bi₂O₃, α-Al₂O₃, ZnMoO₄, Mg₂P2O₇, CsBr ZrO_{2PSZ} Li2WO4 BaMoO₄, MgO ZrO_{2Cubic}, Na₂WO₄, Cs₂WO₄, PbTe, K₂VO₄, NaₓCO₂O₄, Bi₂Te₃, Bi₂VO₄, Ca₃Co4O₉, LiVO₃, KPO₃, SrTiO₃, LiCoO₂, BaCl₂, Bi₂O₃, B2O₃, KOH, PbO, Na₂CO₃, etc.

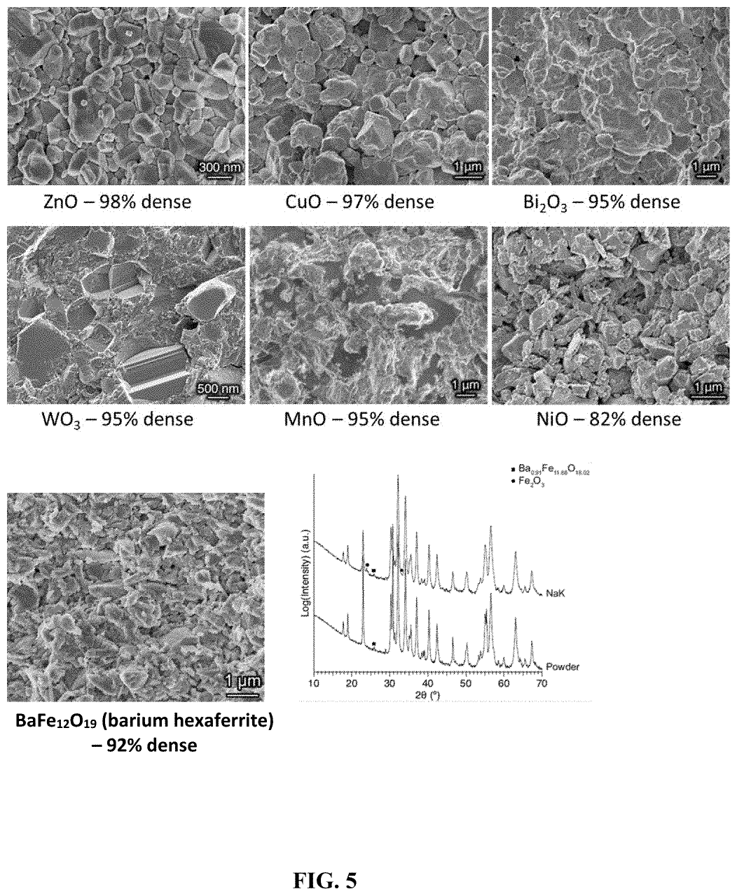

Referring to FIG. 5, in an exemplary embodiment, a 51:49: mol. % ratio of NaOH:KOH:H₂O transport phase was added to CuO as the inorganic compound to form a mixture and to Bi₂O₃ as the inorganic compound to form another mixture. The mixtures can be subjected to heat and pressure so that a (Na,K)OH:H₂O hydroflux was formed. The process can generate a CuO sintered material with 97% density and a Bi₂O₃ sintered material with 95% density in one step. It should be noted that inorganics such as CuO and Bi₂O₃ historically have resisted densities greater than 90% without post-cold sintering heat treatments. Other inorganic compounds mixed with the NaOH:KOH:H₂O transport phase can be ZnO, WO₃, MnO, and NiO, and have resultant densities of: ZnO=98% dense, CuO—97% dense, Bi₂O₃— 95% dense, WO₃— 95% dense, MnO—95% dense, and NiO—82% dense.

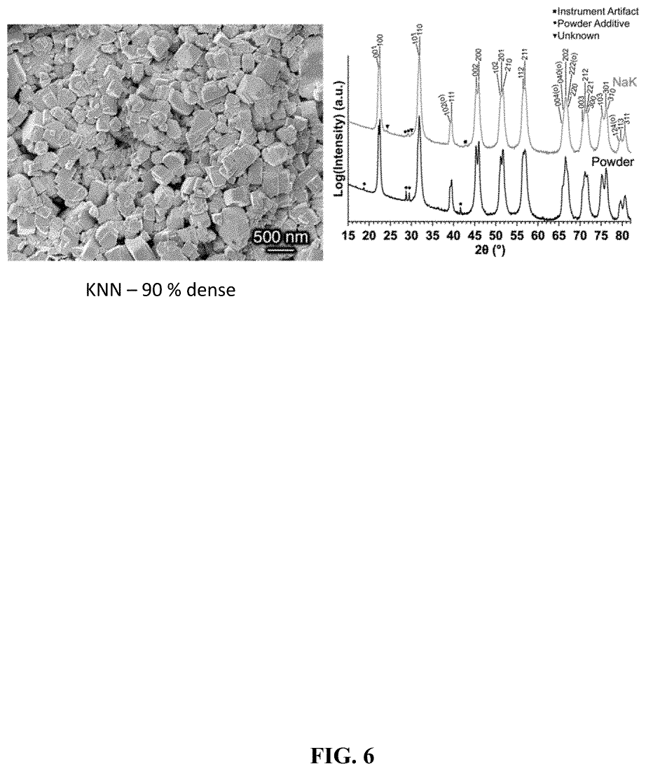

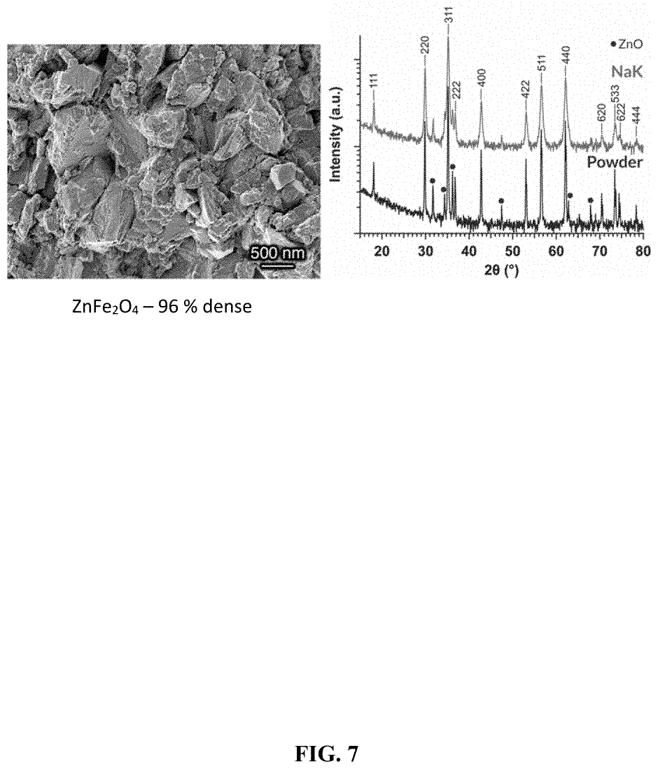

Referring to FIGS. 6-7, embodiments of the process can densify functional ternary materials at temperatures of 300° C. or below. For example, a transport phase can be added to sodium potassium niobate (KNN) as the inorganic compound to form a mixture and to zinc ferrite (ZnFe₂O₄) as the inorganic compound to form another mixture. The mixtures can be subjected to heat and pressure. The process can generate a KNN sintered material with 90% density (see FIG. 6) and a ZnFe₂O₄ sintered material with 96% density (see FIG. 7), each being done in one step.

As noted herein, the flux-based transport phase can be tailored to the specific inorganic compound being used to further enhance densification at the low temperatures. For instance, with oxide inorganic compounds, a eutectic 30:32:38 mol. % mixture of LiOAc.2H2O:NaOAc.3H2O:KOAc can be used as the transport phase. As noted above, a eutectic 51:49 mol. % mixture of NaOH:KOH:H₂O can also be used as the transport phase. The acetate eutectic mixture can be selected because the acetate ligand may be advantageous in low-temperature densification processes. Test results indicate that eutectic hydroxide mixtures can be a better flux as compared to acetate mixtures for many oxide-type inorganic compounds.

As will be discussed below, various experiments were conducted to assess the control of pressure, temperature, and water content, as well as the use of certain fluxes. During experimentation, it was noted that some sintered material samples would have dense, uniform microstructures, while others would not densify at all or would only densify partially and have a significant amount of secondary phase present in the microstructure—i.e., there were inconsistent microstructures in the sintered material samples being produced. Test results indicate that precise control of water content can improve the consistency of microstructures. Test results indicate that better control of pressure and the use of certain fluxes can further enhance material properties of the resultant sintered material.

During the experiments, ceramic powder (e.g., the inorganic compound) was ball-milled to separate agglomerates. The ceramic powder was then weighed, and the desired quantity of transport phase was added. The amount of transport phase added was on the order of a few volume percents. Solid transport phases were added via one of two ways: 1) as a powdered solid or as an aqueous solution that was subsequently dried in a vacuum oven at 80° C. to remove the transport phase liquid water. The transport phase was mixed with the ceramic powder using a Flacktek SpeedMixer to promote uniform distribution. The mixed powder was carefully poured into a pellet die 110, which was then heated to temperatures from room temperature to 300° C. under pressures up to 530 MPa. The samples were pressed between 30 and 60 minutes, although cold sintering time can range anywhere from a few minutes to several hours depending on the material system and transport phase selected.

The primary means of sample characterization included density measurements, x-ray diffraction (XRD), and scanning electron microscopy (SEM). The density of the samples was measured both volumetrically and through the Archimedes method. XRD (Panalytical Empyrean X'Pert Pro) was performed to investigate phase purity of the samples and to identify any secondary phases that formed as a result of the added transport phase. SEM (Zeiss Sigma FESEM) was employed to investigate starting powder characteristics and post-cold-sintered microstructure.

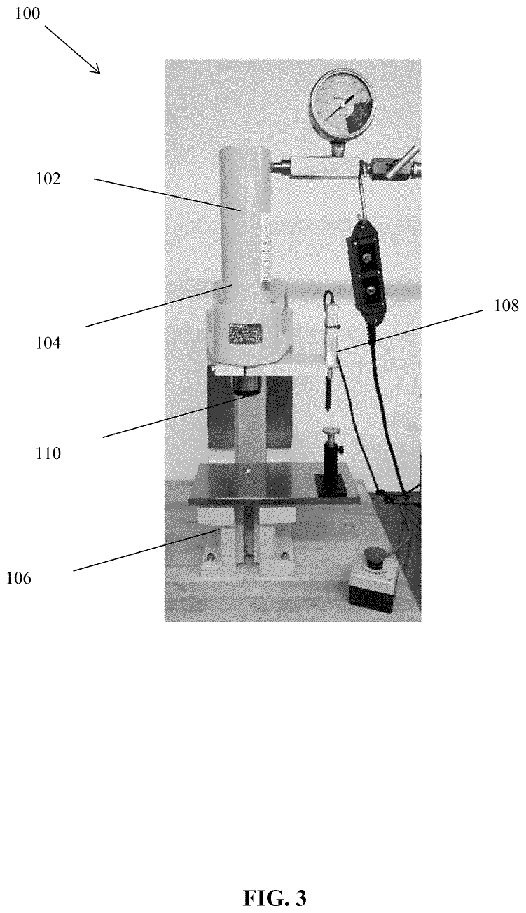

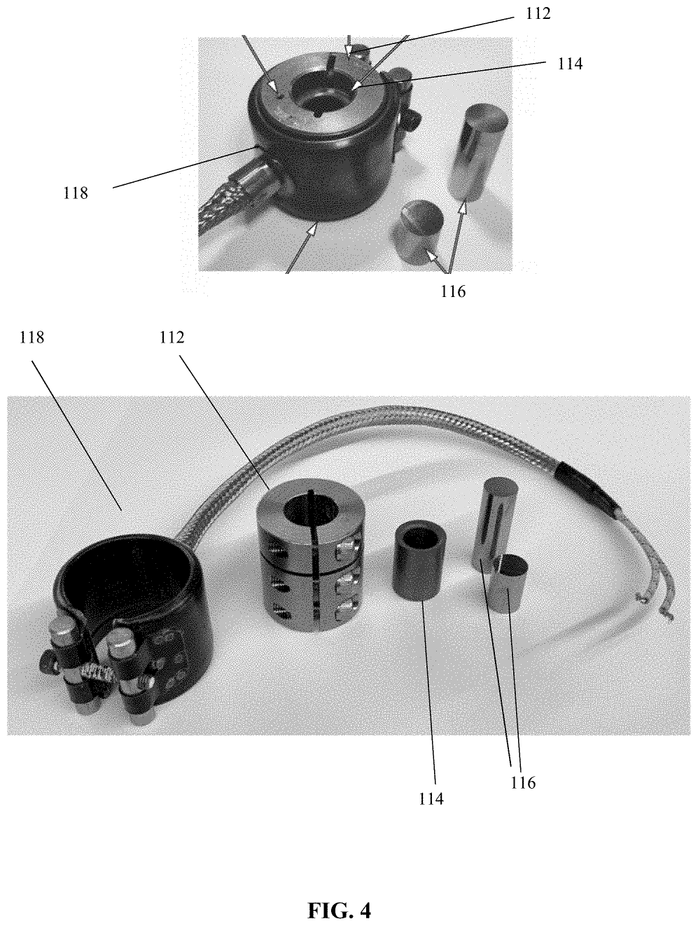

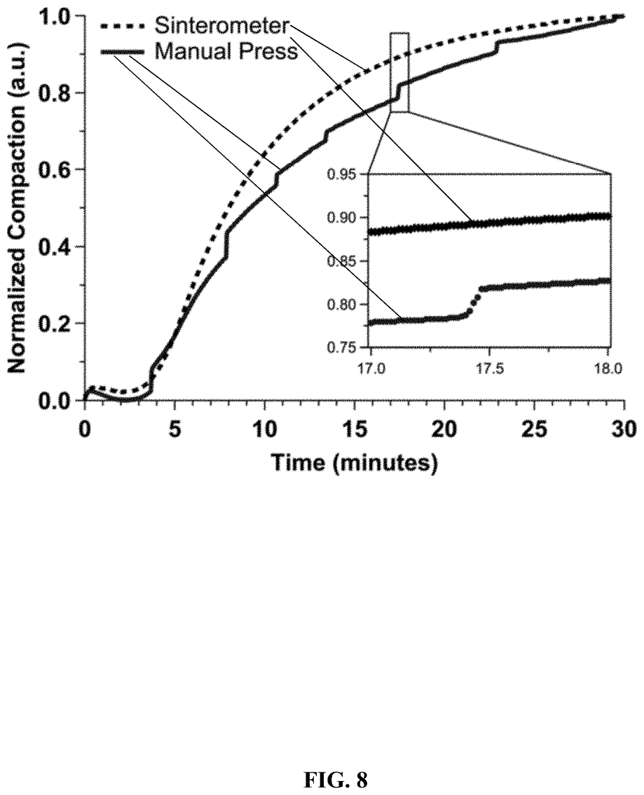

A cold sintering set-up using manual hydraulic press (Carver Model M) and a 440C stainless steel pellet die heated with a manually-controlled 400-watt band heater resulted in experimental variation. A cold sintering set-up with a constant pressure press (e.g., sinterometer 100) and a tungsten carbide die (armadillo die) were designed to provide more consistency between cold sintering runs and the ability to extract in situ densification data. The constant pressure press or sinterometer 100 (see FIGS. 3-4) was used to apply constant pressure to the pellet die 110 while monitoring in situ compaction of the ceramic powder. The sinterometer 100 was powered by an automatic hydraulic pump, resulting in constant, uniform pressure applied at a consistent rate. A linear displacement sensor 108 was mounted on the press to measure compaction as the sample densified. The sinterometer 100 eliminated any large discontinuities in pressure often experienced in the manual press when the operator reapplied pressure as the sample compacted, as shown in the representative compaction vs. time plot for a ZnO sample cold-sintered with the manual press and the sinterometer 100 (see FIG. FIG. 8). The tungsten carbide die 110 was constructed to provide superior chemical resistance, temperature resistance, and hardness. A tungsten carbide die 110 was used because 440C stainless steel pellet dies tended to erode due to transport phases moving more aggressively than aqueous-based solutions. A beneficial feature of the armadillo die 110 was a tungsten carbide drill bushing 114 as the interior lining and tungsten carbide punches, as seen in FIG. 4. These parts were exposed to corrosive environments in the die 110 and needed to be able to withstand erosion and damage. When comparing a 440C stainless die and the tungsten carbide die 110 (both used approximately 20 times with hydroxide-based transport phases) surface profilometer scans reveal that the stainless die had visible roughness due to etching and the tungsten carbide die 110 maintained a smooth surface.

Mechanical strength was evaluated using the Ball-on-Three-Balls (B3B) testing method. The B3B technique is a biaxial bending method that is commonly used to measure the mechanical strength of brittle materials. In this loading situation, the specimen was symmetrically supported by three balls on one face and loaded by a fourth ball in the center of the opposite face; this guarantees well-defined three-point contacts. The four balls used had a diameter of 7.92 mm, giving a support radius of 4.57 mm. The samples were placed in the holder such that the top punch side was in tension. A 5-ION pre-load was applied to the three supporting balls to ensure contact between the sample and the four balls. The load was increased at a constant rate of 0.1 mm/min until fracture. Maximum load at fracture was recorded and used to calculate failure stress for every specimen. Samples were tested in air at approximately 22° C. and 62% relative humidity using a standard Instron with a 1 kN load cell.

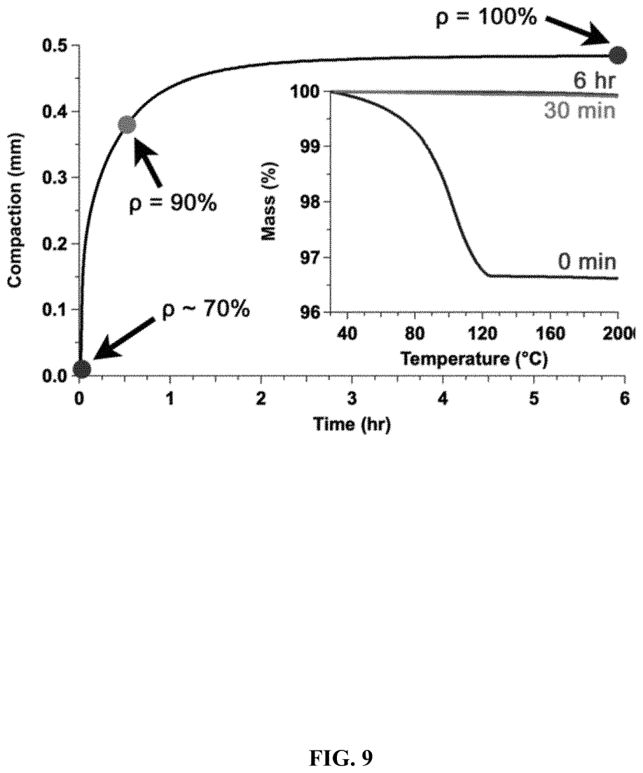

Previous work (with the manual press) determined the conditions necessary to achieve near-fully dense ZnO at 120° C.: 4 wt. % of a 0.8 M aqueous zinc acetate solution as the transport phase and 530 MPa, held for 30 minutes. Minimal work investigating the effect of time had been performed, as it was assumed that all liquid water in the transport phase left the system within 30 minutes, either by evaporation or extrusion out of the die. Additionally, multiple hour experiments were infeasible with a manual press. The automatic nature of the sinterometer 100, however, created an opportunity to study the impact of time on cold sintering through ease of long-term experiments. Data collected by the sinterometer 100 (see FIG. 9) revealed that a ZnO sample cold-sintered for 6 hours with a 0.4 M aqueous zinc acetate solution could achieve a density near 100% of theoretical, while previous 30-minute experiments (with the manual press) resulted in densities of only 90% for this same transport phase.

FIG. 9 sheds light in to whether an aqueous phase is necessary. FIG. 9 shows that there is a 20% increase from 70% to 90% in density between 0 and 30 minutes. Previous assumptions that most of the aqueous-based transport phase would be gone after 30 mins, either via extrusion or evaporation from the die, lead to the stoppage pf the experiments at 30 minutes and to the belief that a molar concentration higher than 0.4 M was necessary to achieve ZnO near full density. However, based on compaction measured by the sinterometer 100, it can be concluded that there is an additional 10% increase in density between 30 minutes and 6 hrs. Additional thermogravimetric analysis (TGA) experiments revealed that ZnO powder mixed with 4 wt. % of the 0.4M transport phase resulted in a mass loss of about 3.5%. However, TGA of a ZnO sample cold-sintered for 30 minutes revealed almost no mass loss, indicating that nearly all of the measurable water was gone. TGA of a ZnO sample cold-sintered for 6 hrs looked comparable to that of the sample cold-sintered for only 30 minutes. This result suggested that if almost all (more than 99.99%) of the liquid water was gone by 30 minutes (yet densification was still proceeding), then the possibly hydrated zinc acetate (i.e., zinc acetate with bound water) added in the transport phase is what is facilitating densification.

During flux crystal growth, a high-temperature melt of an inorganic material is employed to dissolve precursor material and then promote nucleation and growth of a crystal from solution—a similar process to that occurring during cold sintering. In order to suppress the melting point of many fluxes, small quantities of water are added, resulting in a “hydroflux” that spans the regime between flux growth and hydrothermal growth. These “hydrofluxes” are applied to the cold sintering process as the transport phases to generate hydroflux-assisted densification (HAD).

The HAD approach has allowed the spectrum of materials amenable to cold sintering to be significantly expanded. Specifically, hydrated acetate powders of the parent ion in the ceramic powder, a eutectic 30:32:38 mol. % mixture of LiOAc.2H2O:NaOAc.3H2O:KOAc, and a eutectic 51:49 mol. % mixture of NaOH:KOH:H₂O were selected as flux compositions to test. The acetate eutectic mixture was chosen because the acetate ligand has proven advantageous in low-temperature densification processes. The hydroxide eutectic was selected because molten hydroxides are often great transport phases for many oxide materials. Both mixtures have a conveniently low melting temperature, 162° C. for the acetate mixture and 170° C. for the hydroxide mixture. Some of the materials, along with the transport phase used and the resulting relative density, that have been densified by HAD are listed in Table 1 below.

TABLE 1
Ceramics densified at 300° C. or below by
the hydroflux-assisted densification (HAD) technique.

| | | | Relative |
|---|---|---|---|
| Material | Transport Phase | Vol. % | Density |
| ZnO | Zn(OAc)₂•H₂O | 3 | 97% |
| ZnO | (Na, K, Li)OAc•xH₂O | 40 | 87% |
| ZnO | (Na, K)OH | 2 | 98% |
| CuO | (Na, K)OH | 4 | 97% |
| MnO | (Na, K)OH | 10 | 95% |
| WO₃ | (Na, K)OH | 10 | 92% |
| Bi₂O₃ | (Na, K)OH | 16 | 95% |
| ZnFe₂O₄ | (Na, K)OH | 7 | 96% |
| KₓNa₁₋ₓNbO₃ | (Na, K)OH | 8 | 90% |

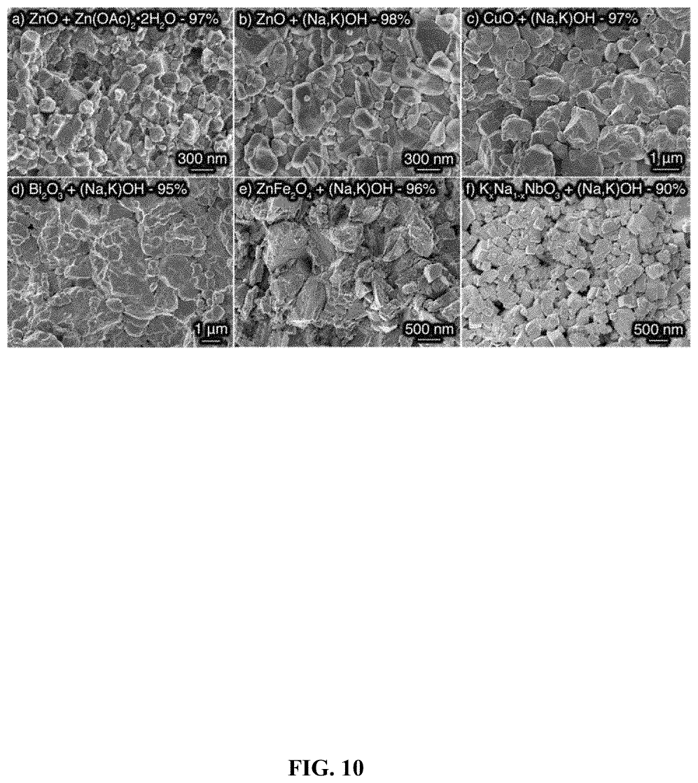

Representative microstructures for the materials of Table 1 are presented in FIG. 10.

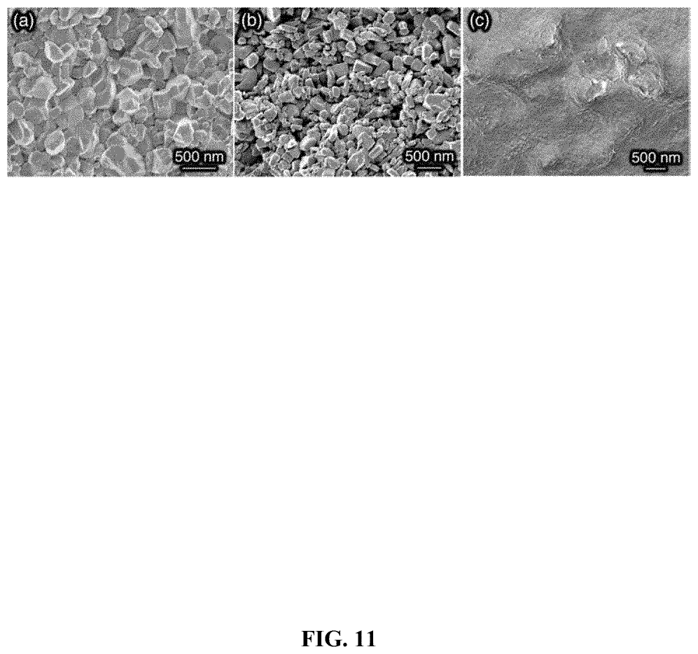

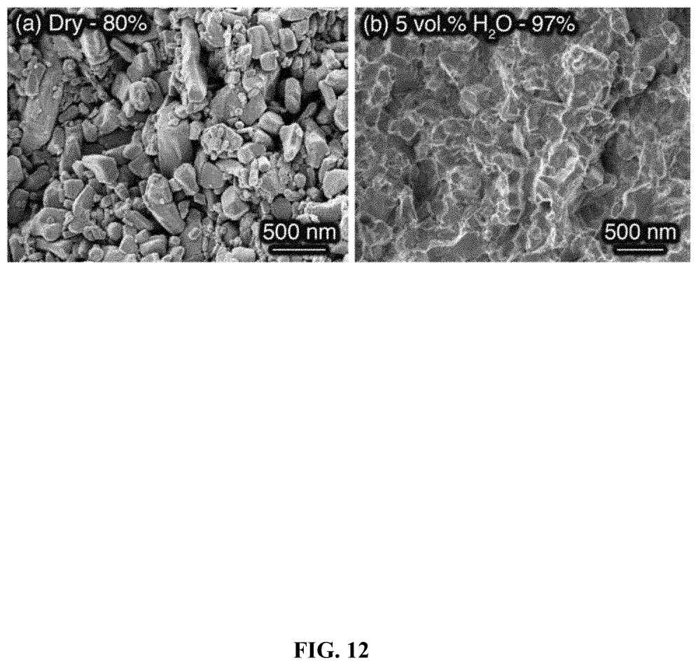

Although initial experiments using the hydroflux-assisted densification technique resulted in great successes in densifying new materials, inconsistent results for equivalent processing conditions quickly became apparent. Some samples would have dense, clean microstructures, while others would not densify at all or would only densify partially and have a significant amount of secondary phase present in the microstructure. (See FIG. 11). At this time, the transport phase was being added as an aqueous solution that was subsequently dried to remove the transport phase water. It was hypothesized that these inconsistent microstructures may be attributed to slight variations in water content, either due to differences in drying or in ambient humidity. In order to test this hypothesis, both the starting ZnO powder and the solid hydroxides for the transport phase were dried in an 80° C. vacuum oven. Two samples were then pressed with equivalent hydroxide transport phase amounts and equivalent cold sintering conditions; however, one sample was “dry” while 0.009 g of water was added to the other. As seen in FIG. 12, this resulted in a density of 80% for the dry sample and 97% for the sample with added water. It should be noted that this quantity of water only equates to 9 microliters or 5 vol. %, only one small drop from a hypodermic needle. Additional comparisons were completed from which it was determined that an amount of water as small as 1 vol % could produce near full density. Water is an essential element of the hydroflux densification process, but very little is necessary—i.e., while the range can be up to 20%, most applications would call for 0.1% to 10% with a smaller amount generally being preferred. The experiments teach that precise control of water content can be beneficial for controlling this hydroflux-assisted densification process. Previous studies have reported that small quantities of adsorbed water can aid or hinder sintering of oxide materials by influencing surface diffusion processes. It is recognized that this may be a contributing factor, but other factors may include suppression of the melting temperature of the flux mixture, promotion of uniform mixing and distribution of the flux amongst the powder particles, and formation of a highly saturated solution with the hydroxides.

The failure stress for each cold-sintered sample was calculated according to the following equation

$${σ}_{f} = f * \frac{{F}_{max}}{{t}^{2}} \qquad ( 1 )$$

where f is a function of sample geometry, Poisson's ratio of the material, and diameter of the balls, Fmax is the fracture load, and t is sample thickness.

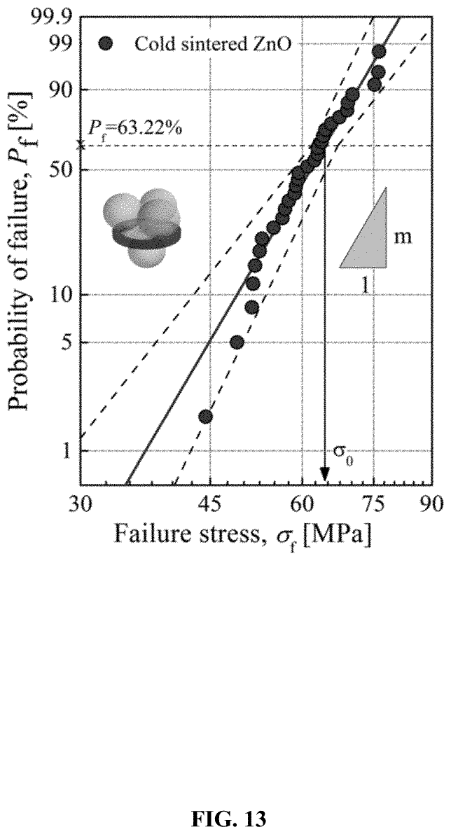

The factor f was determined according to Borger et al. (assuming a Poisson's ratio for ZnO of 0.34) for each specimen, resulting, for instance, in f≈1.82 for 1.5 mm thick samples. Probability of failure vs. failure stress was plotted in a Weibull diagram, which is shown in FIG. 13. The data follows a Weibull distribution. The characteristic strength, σ₀, and Weibull modulus, m, were determined according to the EN 843-5 standards, resulting in σ₀=64.4 [61.8-67.1] MPa and m=8.2 [6.1-10.0], respectively, where the bracketed values represent the 90% confidence intervals. The characteristic strength and Weibull modulus of traditionally sintered ZnO are reported between σ₀≈80 MPa and 120 MPa, and m≈10 and 20, respectively, depending on doping elements, porosity, maximum sintering temperature, and sintering profile. In light of these results, cold-sintered ZnO shows lower characteristic strength (i.e., approx. 40%) than traditionally sintered ZnO, with a slightly higher scatter (i.e., lower m).

Sintering studies have shown that adsorbed water on the surface of oxide ceramic particles can impact sintering behavior by modifying surface diffusion rates. This has been attributed to the formation of surface hydroxyls, which have a smaller size, higher polarizability, and lower charge when compared to O₂-ions, and therefore diffuse faster.

Fully and explicitly knowing the role of water in this process requires tight control of the entire process, including the possibility of atmospheric interactions. Powders and flux mixtures can be stored in a dry environment, but the current set-up requires the mixed powder to be exposed to ambient humidity for 10-15 minutes while being prepared for pressing. It is difficult to monitor or control the amount of water that is adsorbed or absorbed by the ceramic powders and deliquescent fluxes in this ambient environment. Humidity swings up to 30% in one work day have been recorded in the laboratory, indicating a sample made in the morning may differ greatly from one made in the afternoon, even though densification conditions were believed to be the same. Carrying out experiments in a glove box containing a controlled atmosphere, either dry or a constant humidity, would aid in controlling small water contents. Easier distinctions could then be made between concentrated aqueous solutions and eutectic-melting fluxes.

Densification with aqueous transport phases show a strong relationship between density, pressure, and temperature, which is related to hydrothermal conditions in the die. For instance, as temperature was increased, pressure also had to be increased such that the force being applied uniaxially by the press was at least as great as the hydrostatic force due to the water expanding in the semi-sealed die. Hydroflux can be described as flux growth methods combined with subcritical hydrothermal conditions. The available evidence shows that HAD would show a different pressure-temperature trend than that of aqueous-based densification techniques due to the fact that hydrothermal conditions is less essential. This may be a key factor in reducing pressures in low-temperature densification processes, making them easier to implement on a larger scale in industry.

Furthermore, temperature may play a more critical role in HAD because densification fully relies on forming a liquid from the flux mixture, which presumably does not occur below a specific temperature. Preliminary experiments have shown that in the case of the HAD process for a ZnO sample with 2 vol. % (Na,K)OH, densities around 98% of theoretical can be achieved at 200° C., however densities of only 80-85% of theoretical are achieved if the temperature is reduced to 120° C. (the typical temperature used to densify ZnO with aqueous Zn(OAc)₂ solutions). This aligns with the theory that a “melt” is forming from the flux, as a 51:49 mol. % ratio of NaOH:KOH has a eutectic melting point around 170° C. However, as discussed previously, water may significantly suppress this melting point. Temperature may also impact densification kinetics. Sinterometer 100 and TGA experiments can be used to investigate the actual melt temperature of the hydroflux in use and examine densification onsets and rates in the HAD process.

One of the challenges in deducing the densification mechanisms involved in solution-assisted densification processes is that they are often executed in black box systems. Components are added to a pellet die, the process is carried out, and then a dense sample is removed from the die and little knowledge of the reactions that took place in the die is gained. Although the sinterometer 100 has led to great strides forward in terms of in situ monitoring of cold sintering processes, information is still limited to densification rates, onsets, and times rather than chemical reactions. In situ scattering and spectroscopic techniques conducted with a synchrotron and a diamond anvil cell offer a conceivable opportunity to study the fundamental chemical and structural changes occurring during low-temperature solution-assisted densification.

In situ scattering techniques or spectroscopic techniques, such as x-ray absorption spectroscopy (XAS), can be used to study crystallization behavior of ceramics, specifically intermediate phases and reaction rates, during calcination or decomposition reactions. As previously discussed, decomposition reactions of transport phases may contribute to densification. This has been considered in the ZnO—Zn(OAc)₂ system with decomposition values as low as 80° C. However, it has also been demonstrated that both decomposition temperature and decomposition products are significantly impacted by local environment. Therefore, it is likely that the high pressure and varying chemical environment of cold sintering can affect the decomposition of the added transport phase. A previous in situ diffraction study of hydrothermally synthesized ZnO corroborated this idea by reporting that the Zn₅(OH)₈(NO₃)₂.2H₂O precursor underwent a different decomposition path under hydrothermal conditions as compared to the solid state reaction in air, forming different intermediates in the hydrothermal case. Additionally, the decomposition temperature was found to be significantly lower under hydrothermal conditions than values reported in air. Similarly, the external applied pressures and the internal pressures due to any heated vapor phases may alter the reactions taking place during cold sintering, which could be investigated with the powerful capabilities of synchrotron radiation.

Neutron scattering studies have also been performed to study water-solid interactions. Neutron inelastic scattering is particularly sensitive to the mobility of hydrogen atomic nuclei, making this technique extremely useful for analyzing the chemical state of water in a system. Neutron scattering has been used in the past to investigate hydration reactions in cements, evaluating the change in free and bound water. This may also prove useful in determining the role of water in the HAD process, given that the data suggests small percentages of structural or liquid water are critical in facilitating densification. Neutron scattering or other in situ diffraction techniques can aid in determining the state of this water, whether bound or free, and the reactions it facilitates.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of systems, device, and methods of making and using the same have been discussed and illustrated herein, it is to be distinctly understood that the invention is not limited thereto but may be otherwise variously embodied and practiced within the scope of the following claims.

What is claimed is:

1. A method of forming a mixture to be densified, the method comprising:
combining a transport phase with an inorganic compound to form a mixture, wherein the transport phase is configured to assist with redistribution of particulate material during densification.

2. The method of claim 1, wherein:
before, during, or after the mixture is formed, adding structural water to the transport phase to form a solid solution that is within a range from 1% to 20% by weight of water.

3. The method of claim 1, wherein:
the transport phase includes any one or combination of water, water mixed with soluble salts, C1-12 alcohol, ketone, ester, organic acid, and organic acid mixed with soluble salts.

4. The method of claim 1, wherein:
the transport phase is configured to have a boiling point within a range from 100° C. to 1000° C.

5. The method of claim 1, wherein:
the inorganic compound includes any one or combination of a ceramic, a metal oxide, a lithium metal oxide, a non-lithium metal oxide, a metal carbonate, a metal sulfate, a metal selenide, a metal fluoride, a metal telluride, a metal arsenide, a metal bromide, a metal iodide, a metal nitride, a metal sulphide, and a metal carbide.

6. The method of claim 1, wherein:
the inorganic compound includes any one or combination of ZnO, Li₂MoO₄, KH₂PO₄, V₂O₅, NaCl, MoO₃, NaCl, Li₂CO₃, BiVO₄, LiFePO₄, Li_{1.5}Al_{0.5}Ge_{1.5} (PO₄)₃, WO₃, ZnTe CsSO₄, AgVO₃, LiCoPO₄, Li_{0.5x}Bi_{1-0.5x}MoₓV₁₋ₓO₄, V2O₃, AgI, Li₂MoO₄, Na₂ZrO₃, KH₂PO₄, V₂O₅, CuCl, Na₂Mo₂O₇, BaTiO₃, Ca₅(PO4)₃(OH), ZnO, ZrF₄, K₂Mo2O₇, NaNO₂, (LiBi)_{0.5}MoO₄, Bi₂O₃, α-Al₂O₃, ZnMoO₄, Mg₂P2O₇, CsBr ZrO_{2PSZ} Li2WO4 BaMoO₄, MgO ZrO_{2Cubic}, Na₂WO₄, Cs₂WO₄, PbTe, K₂VO4, NaₓCO₂O₄, Bi₂Te₃, Bi₂VO₄, Ca₃Co4O₉, LiVO₃, KPO₃, SrTiO₃, LiCoO₂, BaCl₂, Bi₂O₃, B2O₃, KOH, PbO, and Na₂CO₃.

7. A mixture formulation for a sintered material, comprising:
an inorganic compound; and
a transport phase configured to assist with redistribution of particulate material during densification.

8. The mixture formulation of claim 7, wherein:
the transport phase is a solid solution of an organic, inorganic, or hybrid salt and water within a range from 1% to 20% by weight of water, wherein the water-salt combination produces solubility required for a particulate phase to facilitate densification.

9. The mixture formulation of claim 7, wherein:
the transport phase includes any one or combination of water, water mixed with soluble salts, C1-12 alcohol, ketone, ester, organic acid, and organic acid mixed with soluble salts.

10. The mixture formulation of claim 7, wherein:
the transport phase is configured to have a boiling point within a range from 100° C. to 1000° C.

11. The mixture formulation of claim 7, wherein:
the inorganic compound includes any one or combination of a ceramic, a metal oxide, a lithium metal oxide, a non-lithium metal oxide, a metal carbonate, a metal sulfate, a metal selenide, a metal fluoride, a metal telluride, a metal arsenide, a metal bromide, a metal iodide, a metal nitride, a metal sulphide, and a metal carbide.

12. The mixture formulation of claim 7, wherein:
the inorganic compound includes any one or combination of ZnO, Li2MoO₄, KH2PO₄, V₂O₅, NaCl, MoO₃, NaCl, Li₂CO₃, BiVO₄, LiFePO₄, Li_{1.5}Al_{0.5}Ge_{1.5} (PO₄)₃, WO₃, ZnTe CsSO₄, AgVO₃, LiCoPO₄, Li_{0.5x}Bi_{1-0.5x}MoₓV₁₋ₓO₄, V2O₃, AgI, Li₂MoO₄, Na₂ZrO₃, KH₂PO₄, V₂O₅, CuCl, Na₂Mo₂O₇, BaTiO₃, Ca₅(PO4)₃(OH), ZnO, ZrF₄, K₂Mo2O₇, NaNO₂, (LiBi)_{0.5}MoO₄, Bi₂O₃, α-Al₂O₃, ZnMoO₄, Mg₂P2O₇, CsBr ZrO_{2PSZ} Li2WO4 BaMoO₄, MgO ZrO_{2Cubic}, Na₂WO₄, Cs₂WO₄, PbTe, K₂VO4, NaₓCO₂O₄, Bi₂Te₃, Bi₂VO₄, Ca₃Co4O₉, LiVO₃, KPO₃, SrTiO₃, LiCoO₂, BaCl₂, Bi₂O₃, B2O₃, KOH, PbO, and Na₂CO₃.

13. A method of forming a densified material, the method comprising:
combining a transport phase with an inorganic compound to form a mixture;
allowing fluxes to form in the mixture; and
applying pressure and temperature to promote mass transport and particle consolidation to a dense and robust polycrystalline body that is a compact.

14. The method of claim 13, wherein generating the densified material consists essentially of:
combining a transport phase with an inorganic compound to form the mixture;
adding water to the transport phase before, during, or after combining the transport phase with the inorganic compound;
allowing fluxes to form in the mixture;
applying pressure and temperature to activate mass transport between grains of inorganic material of the inorganic compound leading to densification; and
providing sufficient time to convert an initial particle compact into a dense and robust polycrystalline body.

15. The method of claim 13, further comprising:
allowing the transport phase to partially solubilize the inorganic compound to form the mixture.

16. The method of claim 13, further comprising:
adding water to the transport phase before, during, or after combining the transport phase with the inorganic compound; and
allowing the added water to suppress the melting temperature of the transport phase during the application of pressure and temperature, causing either more rapid transport at elevated temperatures or transport at net lower temperatures.

17. The method of claim 13, further comprising:
allowing a high-temperature melt of the initially solid transport phase material, melted during the application of pressure and temperature to dissolve precursor material in one location of the compact, and promote nucleation of new crystals in another location of the compact.

18. The method of claim 13, further comprising:
generating a hydro-flux that spans a regime between flux growth and hydrothermal growth so that an intersection of hydrothermal and flux-based crystal growth in the phase diagram introduces a mass transport phase at temperatures at or near a boiling point of the transport phase, the mass transport phase being a non-aqueous solution.

19. The method of claim 13, wherein:
applying pressure comprises applying pressure within a range from 30 Mpa to 5,000 Mpa.

20. The method of claim 13, wherein:
applying temperature comprises applying temperature within a range from 100° C. to 300° C.
